(19) United States
(12) Patent Application Publication
(10) Pub. No.: US 2007/0072970 A1
(43) Pub. Date: Mar. 29, 2007

(54) Flame-proofed polyamide molding materials and the use thereof

(76) Inventor: Ewald Schneider, Fuerstenau (CH)

Correspondence Address: MARSHALL & MELHORN, FOUR SEAGATE, EIGHT FLOOR, TOLEDO, OH, 43604, US

(21) Appl. No.: 10/574,721

(22) PCT Filed: Oct. 6, 2004
(86) PCT No.: PCT/EP04/11154

§ 371 Date: Dec. 7, 2006

(30) Foreign Application Priority Data
Oct. 6, 2003 (DE) 103 46 326.7

(51) Int. Cl. C08K 5/53; C08L 77/00

(52) U.S. Cl. 524/126; 524/538

(57) ABSTRACT

The invention relates to halogen-free flameproof moulding compounds based on mixtures of aliphatic and partly aromatic polyamides, which contain salts of phosphinic acids as flameproofing agents. Furthermore, the invention relates to the use of the polyamide moulding compounds according to the invention for producing moulded articles, in particular into components for the electrical and electronics industry.

The invention relates to halogen-free flameproof moulding compounds based on mixtures of aliphatic and partly aromatic polyamides which contain salts of phosphinic acids as flameproofing agents. Furthermore, the invention relates to the use of the polyamide moulding compounds according to the invention for producing moulded articles, in particular into components for the electrical and electronics industry.

Moulding compounds based on aliphatic polyamides are used for producing moulded articles in a multiplicity of application spheres because of their outstanding profile of properties. Polyamide moulding compounds with flame-retardant properties are required in particular for components in the electrical and electronics industry in order to ensure adequate fire protection.

Polyamides are frequently provided with a flame-retardant treatment by the addition of halogen compounds. Halogen-containing polyamide moulding compounds are toxicologically questionable in addition to other disadvantages since they release halogen-containing substances during disposal by incineration. For this reason, some halogen-free flameproofing systems for polyamides have been developed.

DE 1 931 387 describes the addition of red phosphorus to polyamides. Moulding compounds of this type have an inherent dark colour, which restricts the possibilities for colouration. Furthermore, during production and processing of polyamide moulding compounds with red phosphorus as flameproofing agent, considerable safety precautions are necessary because of the formation of toxic phosphine.

The use of inorganic flameproofing agents, such as e.g. magnesium hydroxide, is known from DE 195 25 873. High supplementary quantities are required for adequate flameproofing, which leads to moulding compounds with reduced strength and high brittleness.

Nitrogen-containing flameproofing agents, such as e.g. melamine cyanurate, are described amongst others in EP 0 614 933. In polyamides, in particular in formulations reinforced with glass fibres, they have limited efficacity.

For glass-fibre reinforced polyamide moulding compounds, phosphorus/nitrogen-containing flameproofing systems, such as e.g. melamine-polyphosphate, are proposed amongst others in EP 0 782 599. For an inflammability classification according to UL94 of V0, supplementary quantities of at least 25% by weight are required, which produces moulding compounds with low breaking elongation which is not adequate for every application.

Phosphorus compounds are proposed as a further group of halogen-free flameproofing agents. Thus, the use of calcium and aluminium salts of the phosphinic and diphosphinic acids as flameproofing agents for polyamides is described from EP 0 792 912. Polyamide 6 and polyamide 66 are mentioned as particularly suitable polyamides. Moulding compounds produced therefrom with a supplementary quantity of 30% by weight achieve the inflammability classification V0 according to UL94 with a test piece thickness of 1.2 mm. The necessity for higher dosages of these phosphinates is also demonstrated in EP 1 024 167 A1. As can be deduced from Table 1 of EP 1 024 167, for glass-fibre reinforced polyamide 6, far greater than 20% by weight is required, for glass-fibre reinforced polyamide 66 over 30% by weight of aluminium phosphinate is required in order to achieve a UL94 classification of V0. High supplementary quantities of this type have a negative effect on the mechanical properties. If the moulding compounds are brittle due to low breaking elongation, this can lead to problems, for example in the case of components with snap connections, as are frequently produced in the electrical industry. The components are normally assembled within a short time of being produced by injection moulding, i.e. without conditioning, where considerable disruption occurs if these snap connections break off due to the brittleness of the material. In order to preclude this, moulding compounds with a breaking elongation in the newly moulded state of at least 2% are required for these applications.

Starting herefrom, the object of the present invention is to propose a new polyamide moulding compound which is significantly improved in its mechanical properties, in particular in its breaking elongation, relative to the state of the art, in particular relative to the polyamide moulding compounds of EP 1 024 167. The polyamide compound should furthermore fulfil the requirements according to the inflammability class V0 according to UL94 with a test piece thickness of maximum 0.8 mm.

This object is achieved by the features of patent claim 1.

Surprisingly, it was now found that the moulding compounds defined in claim 1 make possible the production of moulded articles with improved mechanical properties, in particular with a breaking elongation in the newly moulded state of at least 2%. The moulding compounds according to the invention are furthermore distinguished in that, relative to the state of the art, significantly low supplementary quantities of salts of phosphinic acid as flameproofing agent can be used, and in that nevertheless an inflammability classification according to UL94 of V0 is achieved. According to the invention, this effect is obviously achieved in that, in the case of the moulding compounds of the invention based on aliphatic polyamides, a part of the aliphatic polyamine is replaced by a partly aromatic polyamide.

The subject of the invention is hence a flameproof polyamide moulding compound, comprising
a) 20-80% by weight of one or more aliphatic polyamides
b) 1-40% by weight of one or more partly aromatic polyamides
c) 1-30% by weight of a flameproofing agent, containing a phosphinic acid salt of formula (I) and/or a diphosphinic acid salt of formula (II) and/or polymers thereof 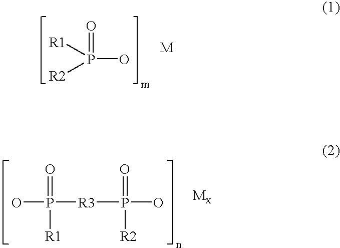
wherein
R¹, R² are the same or different and mean C₁-C₆ alkyl, linear or branched, and/or aryl,
R³ means C₁-C₁₀ alkylene, linear or branched, C₆-C₁₀ arylene, -alkyl arylene or aryl alkylene;
M means metal ion from the 2^{nd} or 3^{rd} main or auxiliary group of the periodic table;
m means 2 or 3;
n means 1 or 3;
x means 1 or 2,
d) 5-60% by weight of a fibre- or particle-like filler or mixtures thereof
e) 0.05-10% by weight of normal additives, comprising stabilisers, processing aids, anti-dripping agents, colourants, pigments, etc.

Homopolyamides and copolyamides can be used as aliphatic polyamides (a) according to the invention, the periodical units of which are derived from aliphatic amines and aliphatic dicarboxylic acids or from amino carboxylic acids, these amino carboxylic acids also being able to be used in the form of their lactams. Typical representatives are polyamide 6, polyamide 11, polyamide 12, polyamide 66, polyamide 66/6, polyamide 46.

Either homopolyamides or copolyamides can be used as partly aromatic polyamides (b) according to the invention, the periodical units of which are derived from dicarboxylic acids and diamines and also from amino carboxylic acids or respectively the corresponding lactams. Suitable dicarboxylic acids are aromatic and aliphatic dicarboxylic acids, such as for example terephthalic acid, isophthalic acid, adipinic acid, azelaic acid, sebacic acid, dodecane dicarboxylic acid and 1,4-cyclohexane dicarboxylic acid. Suitable diamines are aliphatic and cycloaliphatic diamines, such as for example hexamethylene diamine, nonamethylene diamine, decamethylene diamine, dodecamethylene diamine, 2-methylpentamethylene diamine, 1,4-cyclohexane diamine, di-(4-diaminocyclohexyl)-methane, di-(3-methyl-4-aminocyclohexyl)-methane and also diamines with aromatic groups, such as m-xylylenediamine and p-xylylenediamine. Suitable amino carboxylic acids are aminocaproic acid, aminoundecanoic acid and aminolauric acid. Typical representatives are polyamide 61, polyamide 6T/61, polyamide 6T/6, polyamide 6T/66, polyamide 6T/61/66, polyamide 9T, polyamide 10T, polyamide 12T, polyamide 6T/12, polyamide MXD6.

In the case of the flameproofing agents (c) according to the invention, salts of phosphinic acid of formula (I) and/or of diphosphinic acid of formula (II) are concerned, 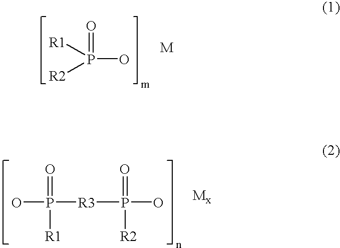
wherein
R¹, R² are the same or different and mean C₁-C₆ alkyl, linear or branched, and/or aryl,
R³ means C₁-C₁₀ alkylene, linear or branched, C₆-C₁₀ arylene, -alkyl arylene or aryl alkylene;
M means metal ion from the 2^{nd} or 3^{rd} main or auxiliary group of the periodic table
m means 2 or 3;
n means 1 or 3;
x means 1 or 2,
   and/or the polymers thereof.

Suitable phosphinic acids for the production of the phosphinic acid salts according to the invention are for example dimethylphosphinic acid, ethylmethylphosphinic acid, diethylphosphinic acid, methyl-n-propylphosphinic acid, methane-di(methylphosphinic acid), ethane-1,2-di(methylphosphinic acid), hexane-1,6-di(methylphosphinic acid), benzene-1,4-di(methylphosphinic acid), methylphenylphosphinic acid, diphenylphosphinic acid.

The phosphinic acid salts according to the invention can be produced according to known methods, such as are described for example in EP 0 699 708. The phosphinic acids are thereby converted in aqueous solution with metal carbonates, metal hydroxides or metal oxides, essentially monomer, possibly also polymer, according to the reaction conditions, phosphinic acid salts being produced.

The phosphinic acid salts according to formulae (I) and (II) can contain ions of metals from the 2^{nd} or 3^{rd} main or auxiliary group of the periodic table, the calcium- and aluminium salts of the phosphinic acids are preferred. These phosphinic acid salts can also be used in the form of mixtures thereof. They are applied preferably in powder form in order to achieve good dispersion during incorporation into the polymer.

The moulding compounds according to the invention contain as component c) 1-30, preferably 5-25, particularly preferred 8-20% by weight of the phosphinic acid salt of formula (I) and/or a diphosphinic acid salt of formula (II) and/or polymers thereof.

As component d), the moulding compounds according to the invention can contain 5-60% by weight of fibre- or particle-like fillers or mixtures thereof. There may be mentioned as examples of fibre-like fillers, fibre-like reinforcing means, such as glass fibres, carbon fibres, aramide fibres, potassium titanate whiskers, glass fibres being preferred. The incorporation of the glass fibres in the moulding compounds can be effected either in the form of endless strands (rovings) or in cut form (short glass fibres). In order to improve the compatibility with the polyamides, the glass fibres used can be provided with a dressing and an adhesive. The diameter of the commonly used glass fibre is in the range of 6-20 μm.

Amongst others, glass balls, chalk, powdered quartz, talcum, wollastonite, kaolin, mica are suitable as particle-like fillers.

Normal additives as component e) are for example heat-insulating materials, antioxidants, light-stability agents, lubricants, mould-release agents, nucleation agents, pigments, colourants, anti-dripping agents.

The flameproof polyamide moulding compounds according to the invention can be produced according to methods known per se. For this purpose, the components are homogenised in a compounding unit, e.g. a twin-screw extruder. A normal procedure comprises introducing the components a) to e) individually or mixed in advance via separate dosing plants into the compounding unit. The homogenisation in the polymer melt is effected at temperatures which are 200-350° C. according to the melting point of the partly aromatic polyamide. The melt is normally drawn off as a strand, cooled and granulated.

The moulding compounds according to the invention are suitable for producing moulded articles according to the injection moulding process.

The following starter materials for producing moulding compounds according to the invention were used in the examples:

Component a)
polyamide a1): polyamide 6, relative viscosity (1% in H2SO4)=2.7
polyamide a2): polyamide 66, relative viscosity (1% in H2SO4)=2.67

Component b)
polyamide b1: polyamide 61/6T with a ratio of isophthalic acid to terephthalic acid of 67:33, relative viscosity (0.5% in m-cresol)=1.72
polyamide b2: polyamide 6T/66 with a molar ratio of terephthalic acid to adipinic acid of 55:45, relative viscosity (0.5% in m-cresol)=1.69
polyamide b3: polyamide 6T/61 with a ratio of terephthalic acid to isophthalic acid of 70:30, relative viscosity (0.5% in m-cresol)=1.135
polyamide b4: polyamide MXD6, relative viscosity (0.5% in m-cresol)=1.85

Component c)
aluminium diethylphosphinate
calcium methylpropylphosphinate

Component d)
standard glass fibres for polyamides, fibre length 4.5 mm, diameter 10 μm

Component e)
Irganox 1098 (Ciba Specialities)
Ca stearate

### EXAMPLES

The starter materials were compounded, in the quantities cited in Table 1 and indicated respectively in % by weight, by means of a ZSK30 twin-screw extruder from Werner & Pfleiderer into the corresponding moulding compounds. The components a), b) and e) were mixed in advance and thus like component c) fed into the feed zone of the extruder via dosing balance scales. The glass fibres were supplied via a side-feeder. The homogenisation of the components was effected at temperatures of 260-310° C.

The moulding compounds were discharged as a strand, cooled in a water bath and subsequently granulated. The granulate was dried to a moisture content of below 0.08% and processed into test pieces on an injection moulding machine. Thereupon the following tests were performed:
inflammability test according to UL-94 on test pieces with a thickness of 0.4, 0.8 or 1.6 mm after normal conditioning
modulus of elasticity according to ISO 527, newly moulded
breaking elongation according to ISO 527, newly moulded
stress at failure according to ISO 527, newly moulded

impact strength at 23° C. according to ISO 179/1eU, newly moulded

TABLE 1

| | | Compara- | | |
|---|---|---|---|---|
| | | tive | Exam- | Exam- |
| | | exam- | ple | ple |
| | | ple 1 | 1 | 2 |
| Composition % by weight | | | | |
| polyamide a1 | | | | |
| polyamide a2 | | 39.4 | 43.0 | 47.4 |
| polyamide b1 | | | 14.4 | |
| polyamide b2 | | | | |
| polyamide b3 | | | | 8 |
| polyamide b4 | | | | |
| Al diethylphosphinate | | 30 | 12 | 14 |
| Ca methylpropylphos- | | | | |
| phinate | | | | |
| Glass fibre | | 30 | 30 | 30 |
| Irganox 1098 | | 0.25 | 0.25 | 0.25 |
| Ca stearate | | 0.35 | 0.35 | 0.35 |
| Tests | | | | |
| Inflammability test | Classi- | | | |
| UL-94 | fication | | | |
| 0.4 mm | | | V-0 | |
| 0.8 mm | | n.k. | V-0 | V-0 |
| 1.6 mm | | V-2 | | V-0 |
| Modulus of elasticity | MPa | 10600 | 10900 | 10600 |
| Stress at failure | MPa | 130 | 147 | 135 |
| Breaking elongation | % | 1.7 | 3.1 | 2.3 |
| Impact strength | kJ/m² | 49 | 52 | 48 |

TABLE 2

| | | Compara- | | |
|---|---|---|---|---|
| | | tive | Exam- | Exam- |
| | | exam- | ple | ple |
| | | ple 2 | 3 | 4 |
| Composition % by weight | | | | |
| polyamide a1 | | 39.4 | 40.0 | 18.7 |
| polyamide a2 | | | | 18.7 |
| polyamide b1 | | | | |
| polyamide b2 | | | 10 | |
| polyamide b3 | | | | |
| polyamide b4 | | | | 12 |
| Al diethylphosphinate | | | | |
| Ca methylpropylphos- | | 25 | 14 | 15 |
| phinate | | | | |
| Glass fibre | | 35 | 35 | 35 |
| Irganox 1098 | | 0.25 | 0.25 | 0.25 |
| Ca stearate | | 0.35 | 0.35 | 0.35 |
| Tests | | | | |
| Inflammability test | Classi- | | | |
| UL-94 | fication | | | |
| 0.4 mm | | | V-0 | |
| 0.8 mm | | n.k. | V-0 | V-0 |
| 1.6 mm | | V-1 | | V-0 |
| Modulus of elasticity | MPa | 11000 | 10900 | 10500 |
| Stress at failure | MPa | 140 | 152 | 145 |
| Breaking elongation | % | 1.8 | 2.9 | 2.8 |
| Impact strength | kJ/m² | 50 | 52 | 58 |

1-10. (canceled)

11. A flameproof polyamide molding compound, comprising
a) 20-80% by weight of one or more aliphatic polyamides;
b) 1-40% by weight of one or more partly aromatic polyamides;
c) 1-18% by weight of a flameproofing agent, containing a phosphinic acid salt of formula (I) and/or a diphosphinic acid salt of formula (II) and/or polymers thereof 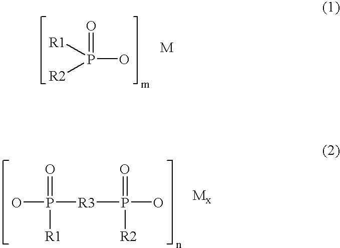
wherein
R¹, R² are the same or different and is C₁-C₆ alkyl, linear or branched, and/or aryl;
R³ is C₁-C₁₀ alkylene, linear or branched, C₆-C₁₀ arylene, -alkyl arylene or aryl alkylene;
M is metal ion from the 2^{nd} or 3^{rd} main or auxiliary group of the periodic table;
m is 2 or 3;
n is 1 or 3;
x is 1 or 2;
d) 5-60% by weight of a fibre- or particle-like filler or mixtures thereof; and
e) 0.05-10% by weight by additional additives wherein the sum of the proportions a) to e) is 100% by weight.

12. A flameproof polyamide molding compound, comprising 5-15% by weight of the flameproofing agent.

13. The flameproof polyamide molding compound according to claim 11, wherein the aliphatic polyamides a) are selected from the group formed by homo- and copolyamides, the periodical units of which are derived from aliphatic amines, aliphatic dicarboxylic acids and/or aliphatic amino carboxylic acids, the amino carboxylic acids also being able to be used in the form of their lactams.

14. The flameproof polyamide molding compound according to claim 11, wherein the partly aromatic polyamides b) are selected from the group formed by polyamides, the periodical units of which are derived from at least one aromatic dicarboxylic acid, if necessary from one or more aliphatic dicarboxylic acids and from one or more aliphatic and/or cycloaliphatic diamines.

15. The flameproof polyamide molding compound according to claim 11, wherein the partly aromatic polyamides b) are selected from the group consisting of polyamides, the periodical units of which are derived from at least one aliphatic dicarboxylic acid, if necessary from one or more aromatic dicarboxylic acids and p-xylylenediamine and/or m-xylylenediamine.

16. The flameproof polyamide molding compound according to claim 11, wherein the partly aromatic polyamides b) are selected from the group formed by polyamides, the periodical units of which are derived from terephthalic acid and/or isophthalic acid and if necessary adipinic acid and also hexamethylene diamine.

17. The flameproof polyamide molding compound according to claim 11, wherein a phosphinic acid salt of formula (I) and/or a diphosphinic acid salt of formula (II) and/or polymers thereof, wherein M is calcium or aluminium ions, is used as flameproofing agent c).

18. The flameproof polyamide molding compound according to claim 11, wherein the additional additive is selected from the group consisting of stabilizers, processing aids, anti-dripping agents, colorants and/or pigments.

19. A method of producing molded articles comprising molding an article from the flameproof polyamide molding compound according to claim 11.

20. The method according to claim 19, wherein the molded compound produced therefrom fulfills the requirement according to the inflammability classification V0 according to UL94 with a test piece thickness of maximum 0.8 mm.
